(19) United States
(12) Patent Application Publication
(10) Pub. No.: US 2025/0234078 A1
(43) Pub. Date: Jul. 17, 2025

(54) EAGLE

(71) Applicant: CHARLES ATOE, ATLANTA, GA (US)

(72) Inventor: CHARLES ATOE, ATLANTA, GA (US)

(21) Appl. No.: 19/020,947

(22) Filed: Jan. 14, 2025

Related U.S. Application Data
(60) Provisional application No. 63/621,699, filed on Jan. 17, 2024.

(51) Int. Cl. H04N 23/53; H04M 1/72409; H04M 1/72412; H04N 5/77; H04N 7/18; H04N 23/63

(52) U.S. Cl. CPC H04N 23/53; H04M 1/724097; H04M 1/72412; H04N 5/77; H04N 7/185; H04N 23/631; H04N 23/634

(57) ABSTRACT

The present invention introduces a headgear-mounted device, Eagle, designed to provide users with enhanced situational awareness and multimedia capabilities. The device features a rear-facing camera and a left-side retractable drop-down display screen for real-time visual feedback and other media. The screen is foldable, adjustable, and interfaced with mobile devices via Bluetooth for audio playback and camera control. Additional features include side speakers, a battery level indicator, a power button, a USB charging port, and an embedded rechargeable battery. The headgear boasts a waterproof, lightweight construction, and the camera functions effectively during both day and night conditions. When paired with a smartphone, users can control various device functions, including audio playback and camera feed viewing, with an option to view the feed on either the product screen or the smartphone. The device's interface app enables video recording, photo capture, volume control, battery level display, and video playback, with all recorded media conveniently stored on the smartphone.

### BACKGROUND OR PROBLEM

People traveling alone may be at risk of being attacked from behind unaware by people and animals or be put at risk for being unable to see an approaching vehicle. Without being able to see danger behind, people may be seriously injured. Being unable to make quick decisions due to moving objects out of view can be frustrating. People may be scared to walk, jog, or hike in certain places due to the risk of surprised attacks.

### SOLUTION

Provides users with a lightweight, waterproof headgear device that allows users to see what is happening behind them.
Includes a rear-facing camera on the back of the headgear that transmits a livestream video to a display screen on the front or a smartphone via Bluetooth.
Features speakers that can be placed in the ears to listen to music, take phone calls, or hear any other type of audio while wearing the device.
Utilizes a rechargeable battery to ensure the device can be consistently used for long periods of time while traveling.
Improves safety and security while offering entertainment when walking, jogging, hiking, cycling, using a scooter or otherwise being outdoors, along with military personnel, law enforcement, and security officers.

### DETAILED DESCRIPTION OF INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description in the claims.

Eagle is a device that allows users to see what is happening behind them. The device is worn on the head and features a rear-facing camera and a corresponding left side retractable drop-down display screen from the left side of the ear towards the front for camera feed and other media. The screen can be adjusted to a desired angle, or it can be folded and closed when not in use. The device also includes Bluetooth connectivity for mobile devices, two side speakers near each ear, a light indicating the battery level, a power button, a USB charging port and an imbedded rechargeable battery for the power source.

The headgear features a waterproof and lightweight construction. The rear-facing camera can function during both day and night hours. When interfaced with a smartphone, users can control different functions on the headgear like playing audio through the speakers, viewing and listening to the camera, or from a smartphone. The transmission from the camera should have the option to either view the feed through the product screen or the smart phone. However, when the product screen is folded to the side, the only option is to view and listen on smartphone via the ear speakers through Bluetooth.

The interface app on smartphones should have full functionality of the product, including video recording, taking photos, volume control, the product's indicating the battery power level, video playback, and more, that are stored on the smartphone. Overall, users can maintain awareness of what is going on behind them through the camera. Exact size, measurement, construction, and design specifications may vary upon further development and manufacturing.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

### SUMMARY

Eagle is a wearable headgear device equipped with a rear-facing camera and a display screen that interfaces with a smartphone, enabling users to easily view people, animals, vehicles, and other moving objects behind them. The headgear improves safety while outdoors and aids in preventing individuals from getting a surprised attacked or impending dangers while in an isolated environment.

### DETAILED DESCRIPTION OF DRAWINGS ATTACHED

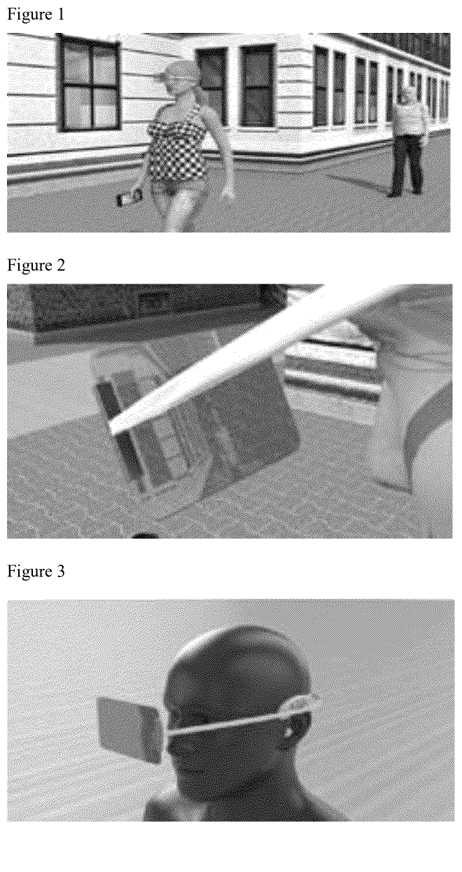

FIGS. 1 and 2 Shows how a person following the wearer can be easily seen through the display screen and or the smartphone.

FIG. 3 Shows how the device is worn.

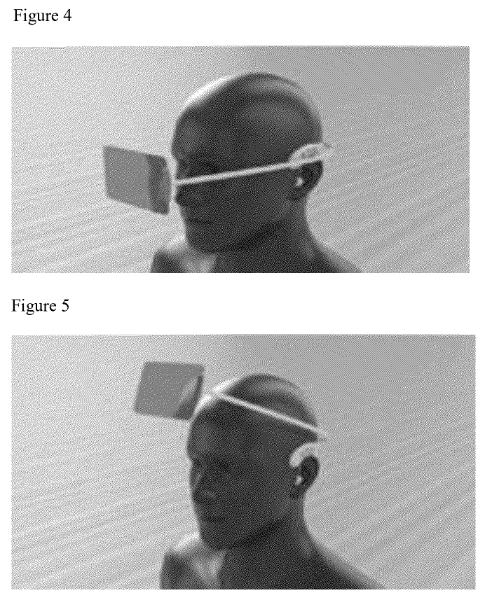

FIG. 4 Shows how the headgear is adjustable to different angles.

FIG. 5 Shows a close-up view of the earpiece and how the device is Bluetooth compatible.

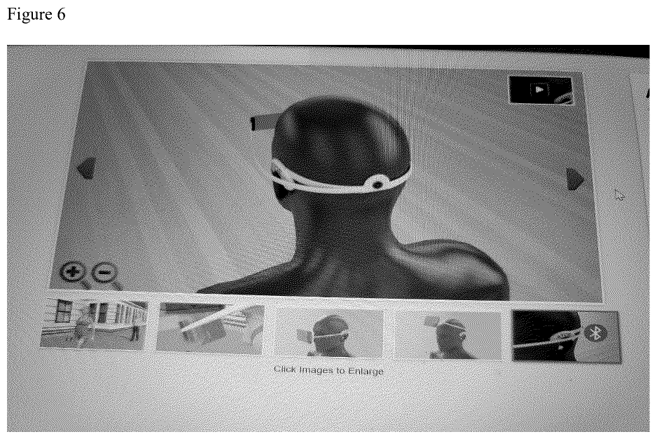

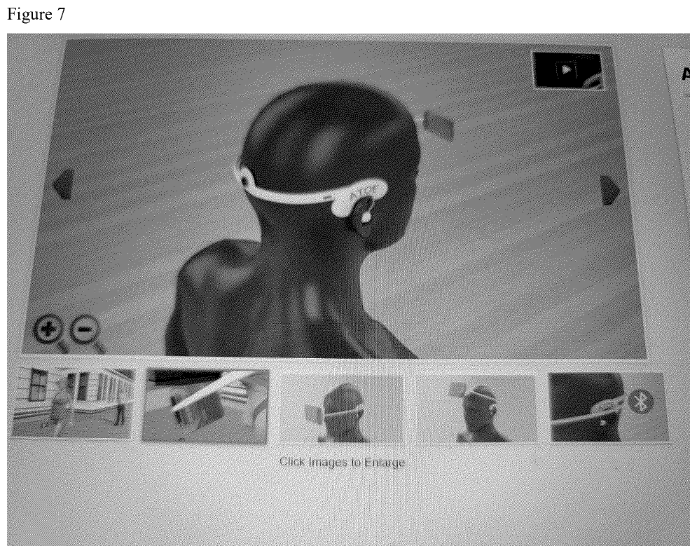

FIG. 6 Shows a close-up view of the rear camera.

FIG. 7 Shows a close-up view of the right ear.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. A headgear-mounted device comprising a rear-facing camera and a left-side retractable drop-down display screen for real-time visual feedback and other media.

2. The headgear of claim 1, wherein the display screen is foldable and adjustable, enabling the user to customize the viewing angle or close it when not in use.

3. The headgear of claim 1, wherein Bluetooth connectivity allows for wireless interfacing with mobile devices, providing control over audio playback and camera functionality.

4. The headgear of claim 1, further comprising two side speakers located near the user's ears for audio playback.

5. The headgear of claim 1, further comprising a visual indicator to display the device's current battery level.

6. The headgear of claim 1, further comprising a power button to control the device's on/off status.

7. The headgear of claim 1, further comprising a USB charging port for replenishing the battery and providing a power source.

8. The headgear of claim 1, comprising a rechargeable internal battery that serves as the primary power source.

9. The headgear of claim 1, characterized by its waterproof and lightweight construction.

10. The headgear of claim 1, wherein the rear-facing camera is equipped to function effectively during both day and night conditions.

11. The headgear of claim 1, wherein the device can interface with a smartphone, allowing users to control various functions, including audio playback and camera feed viewing.

12. The headgear of claim 11, wherein the device allows for the option to view camera feed on either the product screen or the smartphone.

13. The headgear of claim 12, wherein when the product screen is folded to the side, the camera feed is exclusively viewable on the smartphone.

14. The headgear of claim 11, wherein a corresponding smartphone application offers comprehensive control over device functions, such as video recording, photo capturing, volume adjustment, battery power level display, and video playback.

15. A method for using the headgear-mounted device of claim 1, comprising the steps of: wearing the device on the user's head, activating the camera and display screen, and utilizing the device to view and record what is happening behind the user.

16. The method of claim 15, further comprising the step of wirelessly interfacing the device with a smartphone for additional functionality and control options.

17. The method of claim 16, wherein the user can choose to view the camera feed on either the product screen or the smartphone.

18. The method of claim 17, further comprising folding the product screen to the side when not in use, which automatically redirects the camera feed exclusively to the smartphone.

19. The method of claim 18, wherein the user can access and manage recorded video and captured photos stored on the smartphone.

20. A system comprising the headgear-mounted device of claim 1 and a smartphone with a corresponding interface application for remote control and storage of recorded media.
